(19) United States
(12) Patent Application Publication
(10) Pub. No.: US 2010/0306007 A1
(43) Pub. Date: Dec. 2, 2010

(54) ENTERPRISE PROJECT TYPES

(75) Inventors: Pradeep GanapathyRaj, Bellevue, WA (US); Samuel Y. Chung, Kirkland, WA (US); Alexandru Savescu, Issaquah, WA (US); Lucas Allen Humphrey, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/475,607

(22) Filed: Jun. 1, 2009

(51) Int. Cl. G06Q 10/00; G06F 17/30

(52) U.S. Cl. 705/8; 707/E17.044; 715/845

(57) ABSTRACT

A selection of an enterprise project type is received from a plurality of enterprise project types. The enterprise project type may include a plurality of pages. Each page may include a plurality of input fields for collecting values of properties. A project page from the enterprise project type is displayed. The project page may include a create project interface element. When a selection of the create project interface element is received, an instance of the enterprise project type is generated. The instance of the enterprise project type represents an entity, such as a project plan, an application plan, or a product plan. The pages are displayed. The values of properties are collected through the pages. The entity is generated by transforming the values of properties into the entity.

### BACKGROUND

Generally, project management applications help users define project goals, plan tasks and allocate resources, display a project plan including a schedule, and carry out and manage projects. A project plan may define tasks. The schedule may define the sequence in which the tasks occur, the resources needed to complete each task, and calendar information pertaining to the tasks. Each task may be defined to include one or more attributes (e.g., scheduled dates, task length, cost, etc.). A user may create a project plan by assigning values to the attributes of each task.

One limitation of some project management applications is the rigidness of the structure used to define projects. The structure of a project might include various elements, such as the properties of the project, the organization of the properties, the workflow associated with the project, and the visual representation of the project. These elements are commonly fixed by project management applications or require heavy customization to attain a desired level of flexibility. The rigidity of project management applications may cause frustration on the part of users who desire to create projects having a structure that is inconsistent with the fixed structure that is natively provided.

It is with respect to these and other considerations that the disclosure made herein is presented.

### SUMMARY

Technologies are described herein for providing an enterprise project type. The enterprise project type is a feature that can be incorporated into a project management application. Generally, the enterprise project type is a wrapper that encapsulates, among other elements, stages, pages, and/or workflows. A stage may contain one or more pages. A project management application may include multiple enterprise project types, each of which enables a user to define a project, an application, a product, and other entities. The enterprise project types can also encompass and facilitate lifecycle management of these entities.

An enterprise project type may be created through an administrative interface. The administrative interface may provide at least two ways in which an administrator can create the enterprise project type. In one way, the administrator may choose not to associate a workflow with a newly created enterprise project type. In this case, the administrative interface may provide a list of pages from which the administrator can select for inclusion in the enterprise project type. In another way, the administrator may choose to associate a workflow with a newly created enterprise project type. In this case, the administrative interface does not provide a list of pages because the selected workflow dictates the stages and pages that are provided by the enterprise project type. Whether a workflow is associated or is not associated with the enterprise project type, a project page may also be associated with the enterprise project type. The project page may refer to the first page that is displayed when an entity of the associated enterprise project type is created.

After one or more enterprise project types are created, a user may access a client interface to create an entity through the enterprise project types. In particular, the client interface may provide a selection of project types from which a user can select one of the enterprise project types. When the user selects one of the enterprise project types, an instance of the enterprise project type is created. When an instance of the enterprise project type has been created by the user, the client interface may display pages as dictated by the enterprise project type. If the enterprise project type is not associated with a workflow, then the client interface may display the pages included in the enterprise project type. If the enterprise project type is associated with a workflow, then the client interface may display stages and pages according to the workflow. For example, the workflow may specify that that the stages and pages be displayed in a certain order and/or according to input specified in previous stages and pages.

Each page displayed to the user may include various input fields in which a user can define properties associated with the entity. For example, the input fields may include text boxes, drop-down menus, radio buttons, and other input interfaces. The input fields included in the pages may be pre-defined by the pages. Once the user has defined the properties contained in the pages provided by the enterprise project type, the client interface may generate the entity based on the properties.

According to one embodiment, a method is provided herein for generating an entity based on an instance of an enterprise project type. According to the method, a selection of an enterprise project type is received from a plurality of enterprise project types. The enterprise project type may include a plurality of pages. Each page may include a plurality of input fields for collecting values of properties. When a selection of the enterprise project type is received, a project page from the selected enterprise project type is displayed. The project page may include a create project interface element. When a selection of the create project interface element is received, an instance of the enterprise project type is generated. The instance of the enterprise project type represents an entity, such as a project plan, an application plan, or a product plan. When the instance of the enterprise project type is generated, the pages are displayed. The values of properties are collected through the pages. The entity is generated by transforming the values of properties into the entity.

It should also be appreciated that the above-described subject matter may also be implemented as a computer-controlled apparatus, a computer process, a computing system, or as an article of manufacture such as a computer-storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIG. 1 is a computer architecture diagram showing an illustrative computer architecture configured to provide an enterprise project type, in accordance with embodiments;

FIGS. 2A-2B are screen display diagrams showing an illustrative implementation of an administrative interface for generating an enterprise project type, in accordance with embodiments;

FIG. 3A-3B are screen display diagrams showing an illustrative implementation of a client interface for generating an entity based on an instance of an enterprise project type, in accordance with embodiments;

FIG. 4 is a diagram showing an illustrative components within an enterprise project type, in accordance with embodiments;

FIG. 5A is a flow diagram illustrating a method for generating an entity based on an instance of an enterprise project type, in accordance with embodiments;

FIG. 5B is a flow diagram illustrating a method for generating an enterprise project type, in accordance with embodiments; and

FIG. 6 is a computer architecture diagram showing an illustrative computer hardware architecture for a computing system capable of implementing the embodiments presented herein.

### DETAILED DESCRIPTION

The following detailed description is directed to technologies for providing an enterprise project type. Through the utilization of the technologies and concepts presented herein, a project management application may provide an administrator interface for creating an enterprise project type and a client interface for creating an entity through an instance of the enterprise project type. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

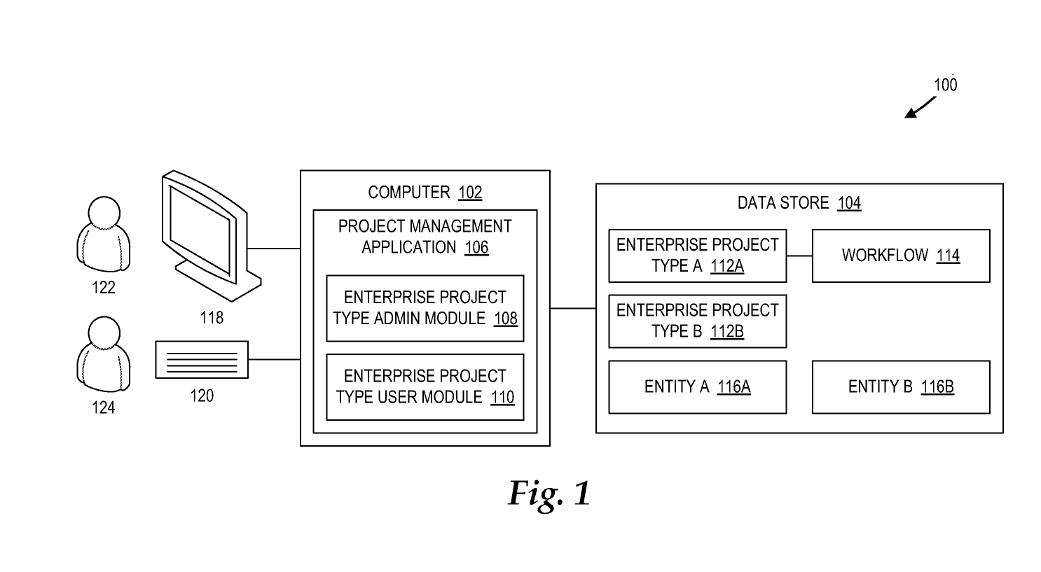

In the following detailed description, references are made to the accompanying drawings that form a part hereof, and which are shown by way of illustration specific embodiments or examples. Referring now to the drawings, in which like numerals represent like elements through the several figures, a computing system and methodology for implementing a project management application will be described. In particular, FIG. 1 illustrates a simplified computer architecture 100. The computer architecture 100 includes a computer 102 coupled to a data store 104. The computer 102 is configured to execute a project management application 106. The project management application 106 includes an enterprise project type admin module 108 and an enterprise project type user module 110.

The data store 104 includes a first enterprise project type 112A and a second enterprise project type 112B. While the first enterprise project type 112A is associated with a workflow 114, the second enterprise project type 112B is not associated a workflow. The data store 104 further includes a first entity 116A and a second entity 116B (collectively referred to as entities 116). As described in greater detail below, in the example illustrated in FIG. 1, the first entity 116A is generated from an instance of the first enterprise project type 112A, and the second entity 116B is generated from an instance of the second enterprise project type 112B.

Also as illustrated in FIG. 1, the computer 102 is coupled to various input/output devices, such as a display 118 and a keyboard 120. Through the input/output devices coupled to the computer 102, an administrator 122 may access a administrative interface (not shown in FIG. 1) provided by the enterprise project type admin module 108, and a user 124 may access a user interface (not shown in FIG. 1) provided by the enterprise project type user module 110. Although the enterprise project type admin module 108 and the enterprise project type user module 110 are illustrated in FIG. 1 as being embodied on one project management application 106 executing on one computer 102, it should be appreciated that the enterprise project type admin module 108 and the enterprise project type user module 110 may be embodied on one or more applications and/or executed on one or more computers. The enterprise project type admin module 108 and the enterprise project type user module 110 enable an enterprise project type feature as described herein according to embodiments.

The enterprise project type feature allows users to define entities outside of the conventional rigid project structure and with a greater level of customization. Examples of entities may include schedule-focused project plans, application plans, product plans, and other representations of processes/items through which a given project, application, product, or process/item can be executed, generated, and/or controlled. The entities may also encompass and facilitate lifecycle management of these processes and items. Although some embodiments described herein may refer primarily to projects and project plans, it should be appreciated that these embodiments may be similarly implemented for other processes and items represented by the entities.

The properties defined for enterprise project types can include a variety of custom metadata inputs, a project schedule tied to a scheduling engine (e.g., the scheduling engine provided by PROJECT SERVER from MICROSOFT CORPORATION), a customized workflow based on a workflow infrastructure (e.g., the workflow infrastructure provided by WINDOWS SHAREPOINT SERVICES (“WSS”) from MICROSOFT CORPORATION), business driver impact evaluation, and other WSS web parts and custom web parts.

In one embodiment, the enterprise project type is a wrapper that encapsulates, among other things, one or more stages, one or more pages, and a workflow. In another embodiment, the enterprise project type is a wrapper that encapsulates one or more pages with no workflow. Each stage may include one or more pages. Each page may be a custom web part that includes one or more input fields with which a user can define values of properties. The input fields may include text boxes, drop-down menus, radio buttons, and other input interfaces. The wrapper may further encapsulate business drivers

As described in greater detail below, the administrative interface enables an administrator or other user with administrative permissions to create an enterprise project type. In an embodiment, the administrative interface provides a user interface configured to create two types of enterprise project types: (1) an enterprise project type with no associated workflow and (2) an enterprise project type with an associated workflow.

In the case of the enterprise project type with no associated workflow, the administrative interface may provide a selection of pages from which the administrator can choose. Thus, the enterprise project type with no associated workflow defines the specific pages that are provided by the enterprise project type. In the case of the enterprise project type with an associated workflow, the administrative interface may provide a selection of workflows from which the administrator can choose one. The workflow defines stages and pages that are provided by the enterprise project type. Thus, the enterprise project type with an associated workflow does not define the specific pages that are provided by the enterprise project type. However, the administrator may still choose the project page.

Also as described in greater detail below, the client interface enables a user to create an entity through an instance of the enterprise project type. In an embodiment, the client interface provides a selection of enterprise project types from which a user can choose. Upon choosing an enterprise project type, the client interface creates an instance of the enterprise project type from which an entity can be created.

If the user selects an enterprise project type with no associated workflow, then the client interface may display a list of the pages defined by the enterprise project type. In this case, the user may have access to each of the pages defined by the enterprise project type. If the user selects an enterprise project type with an associated workflow, then the client interface may display stages and pages in accordance with the workflow. In this case, the user may not have access to each of the stages and pages defined by the workflow because the workflow defines the stages and pages that are displayed.

A user may define values of properties contained in pages provided through the instance of the enterprise project type. Once the user has defined values of properties contained in the pages, the client interface may generate the entity based on the properties. That is, the inputted values of the properties may be transformed into schedule-focused project plans, application plans, product plans, and other representations of processes/items.

Each enterprise project type may correspond to a single project type. In one embodiment, each project type is aligned with individual departments, such as marketing projects, information technology (“IT”) projects, human resources (“HR”) projects, and the like. Projects within the same department may be categorized together if they have a similar project life cycle. In other embodiments, each project type is aligned with other suitable categorizations.

Any number of customizable enterprise project types can be created through the administrative interface. The enterprise project types may be directly accessed through the client interface or programmatically through a suitable application program interface (“API”). The enterprise project types are extendable through the inclusion of additional web parts that provide additional functionality.

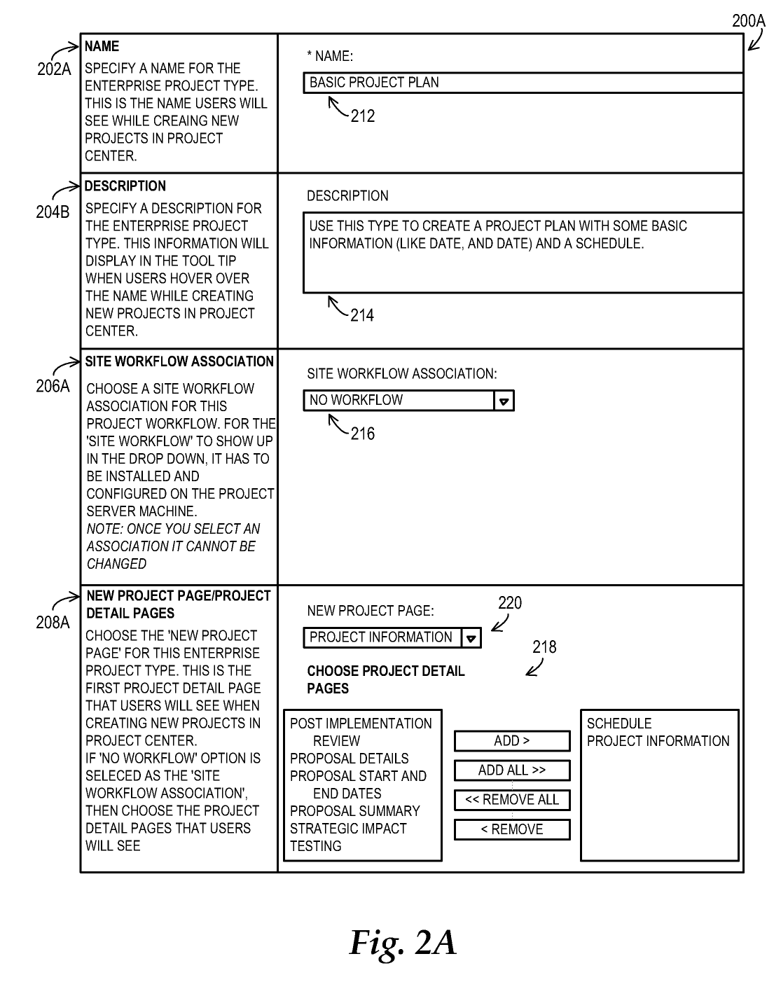

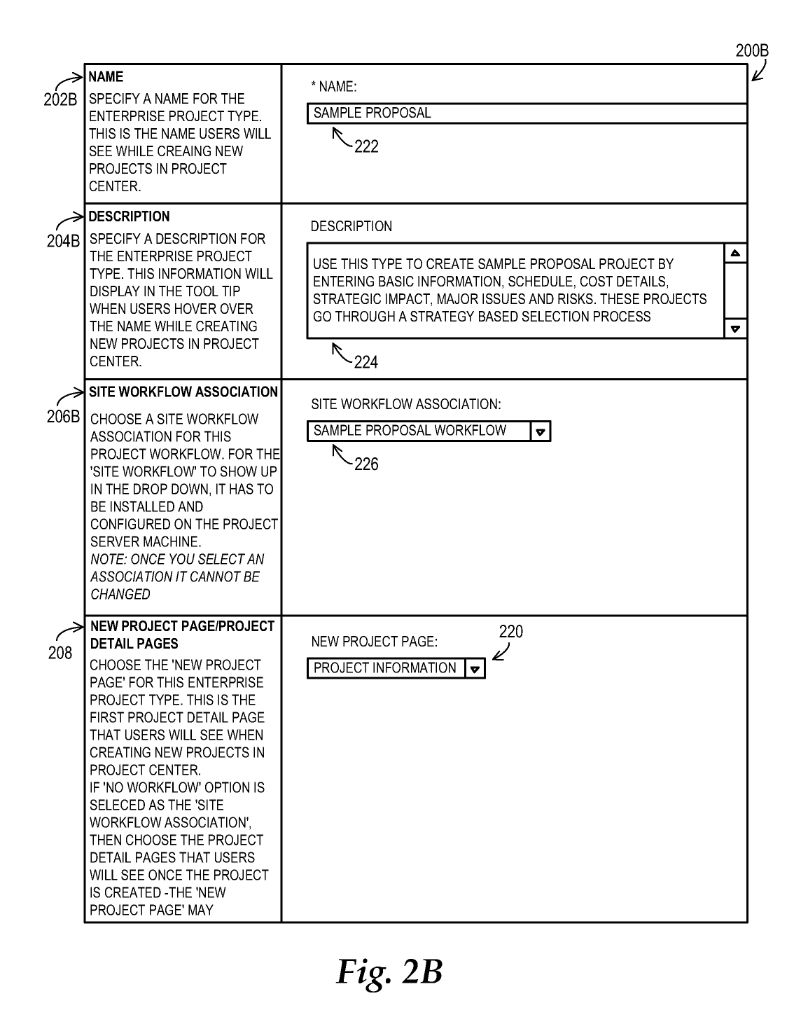

Referring now to FIGS. 2A-2B, additional details regarding the administrative interface will be described. FIGS. 2A-2B show illustrative screen display diagrams of a portion of the administrative interface. In particular, FIG. 2A shows a screen display diagram of the administrative interface configured to enable and administrator to create an enterprise project type with no associated workflow, according to embodiments. FIG. 2B shows a screen display diagram of the administrative interface configured to enable an administrator to create an enterprise project type with an associated work flow, according to embodiments.

Referring to FIG. 2A, a screen display diagram 200A shows an example configuration of a portion of the administrative interface where an administrator creates an enterprise project type with no associated workflow. The administrative interface includes a name section 202A, a description section 204A, a site workflow association section 206A, and a new project page section 208A. The name section 202A includes a text box 212 where the administrator can enter a name for the enterprise project type. As illustrated in FIG. 2A, the administrator has entered the name “Basic Project Plan” into the text box 212.

The description section 204A includes a text box 214 where the administrator can enter a description for the enterprise project type. The site workflow association section 206A includes a drop-down menu 216 where the administrator can select a workflow. The new project page section 208A includes a selection interface 218 where the administrator can select pages to include in the enterprise project type. The selection interface 218 further includes a project page selection interface 220 where the administrator can select a project page for the enterprise project type. As previously described, the project page may refer to the first page that is displayed when an entity of the associated enterprise project type is created. When the administrator does not select a workflow in the drop-down menu 216, the administrative interface makes the new project page section 208A available.

Referring to FIG. 2B, a screen display diagram 200B shows an example configuration of a portion of the administrative interface where an administrator creates an enterprise project type with an associated workflow. The administrative interface illustrated in FIG. 2B includes a name section 202B, a description section 204B, a site workflow association section 206B, and a new project page section 208B. The name section 202B, the description section 204B, the site workflow association section 206B, and the new project page section 208B illustrated in FIG. 2B correspond to the name section 202A, the description section 204A, the site workflow association section 206A, and the new project page section 208B illustrated in FIG. 2A.

The name section 202B includes a text box 222 where the administrator has entered the name “Sample Proposal” for the enterprise interface type. The description section 204B includes a text box 224 where the administrator can enter a description for the enterprise project type. The site workflow association section 206B includes a drop-down menu 226 where the administrator selects a workflow called “Sample Proposal Workflow.” In contrast to the new project page section 208A illustrated in FIG. 2A, the new project page section 208B in FIG. 2B does not include the selection interface 218 where the administrator can select pages to include in the enterprise project type because the workflow dictates the stages and pages provided by the enterprise project type. However, the new project page section 208B includes the project page selection interface 220 where the administrator can select a project page for the enterprise project type.

As previously described, the screen display diagrams 200A-200B shown in FIGS. 2A-2B are merely examples and may show only a portion of the configurable aspects of the enterprise project type. Additional fields (not shown) that may be part of the administrative interface may include, but are not limited to, a default field, a departments field, an image field, and order field, a project plan template field, and a project site template field. The default field may be a check box or other interface element enabling the administrator to specify a particular enterprise project as the default enterprise project type. The departments field may enable the administrator to select departments that have access to the enterprise project type. The image field may enable the administrator to select an image that is associated with the enterprise project type. For example, the image may be shown next to the enterprise project type in various drop-down menus or other interface elements showing the enterprise project type. The order field may enable the administrator to select the position that the enterprise project type is placed within a drop-down menu or other interface element displaying multiple enterprise project types. The project plan template and the project site template may enable the administrator to select a particular project plan template or project site template, if desired.

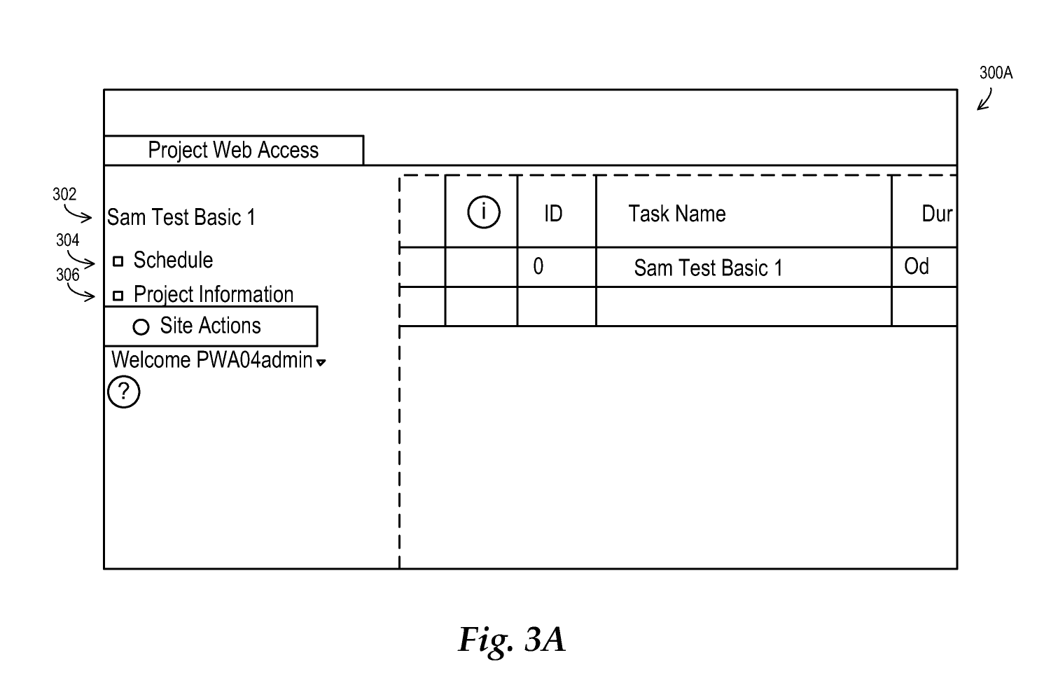

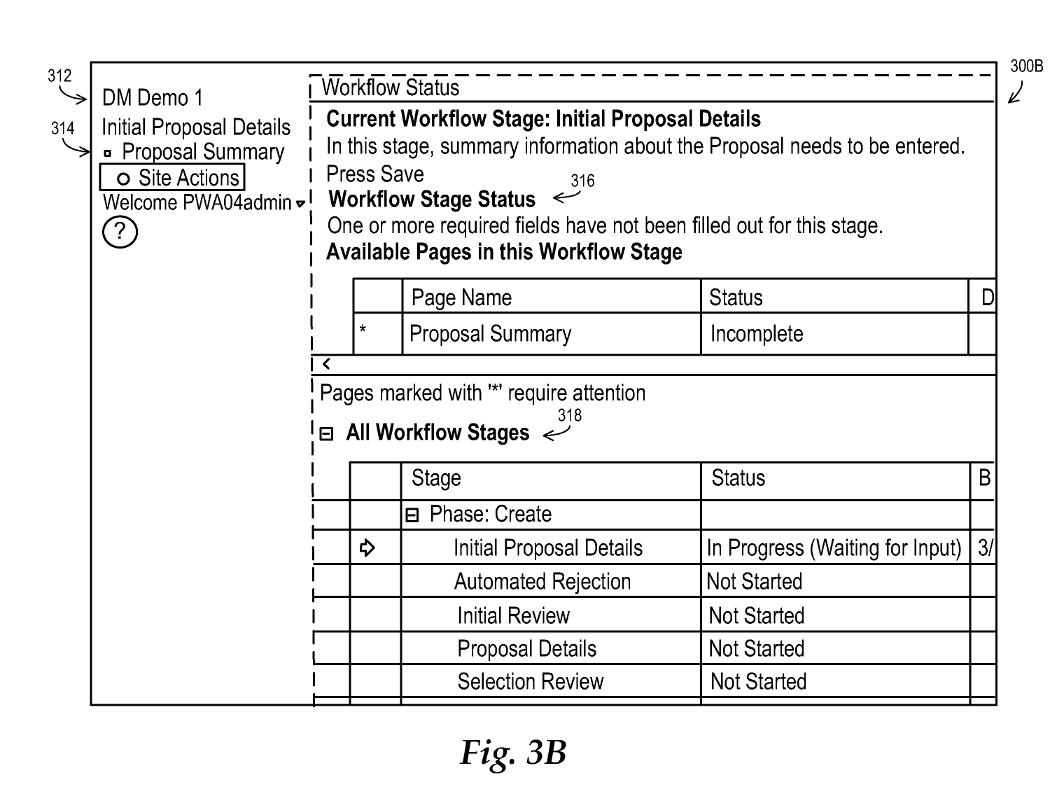

Referring now to FIGS. 3A-3B, additional details regarding the client interface will be described. FIGS. 3A-3B show illustrative screen display diagrams of the user interface. In particular, FIG. 3A shows a screen display diagram of the client interface when a user selects an enterprise project type with no associated workflow, according to embodiments. FIG. 3B shows a screen display diagram of the client interface when a user selects an enterprise project type with an associated workflow, according to embodiments.

Referring to FIG. 3A, a screen display diagram 300A shows an example configuration of a portion of the client interface when a user selects an enterprise project type with no associated workflow. In particular, the user has selected an enterprise project type called “SAM Test Basic 1” as indicated at heading 302. According to the example illustrated in FIG. 3A, the enterprise project type “SAM Test Basic 1” does not have an associated workflow. Underneath the heading 302 is a list of the pages including a schedule 304 and project information 306. In an embodiment, the heading 302 lists all of the pages provided by the enterprise project type. Thus, a user may have access to each of the pages defined by the enterprise project type.

Referring to FIG. 3B, a screen display diagram 300B shows an example configuration of a portion of the client interface when a user selects an enterprise project type with an associated workflow. In particular, the user has selected an enterprise project type called “DM Demo 1” as indicated at heading 312. According to the example illustrated in FIG. 3B, the enterprise project type “DM Demo 1” has an associated workflow. Underneath the heading 312 is a list of pages including a proposal summary 314. In an embodiment, the heading 312 lists only pages as dictated by the workflow associated with the enterprise project type. Thus, at any given time, a user may only have access to the pages permitted by the enterprise project type.

As illustrated in FIG. 3B, the client interface further includes a workflow stage status 316 and a workflow stage list 318. The workflow stage status 316 displays a status indicating whether the user has completed each of the input fields in the pages contained in a given stage. As shown in FIG. 3B, the user has not completed each of the input fields. The user cannot move past the current stage until the user has completed each of the input fields. The workflow stage list 318 includes a list of each of the stages in the enterprise project type.

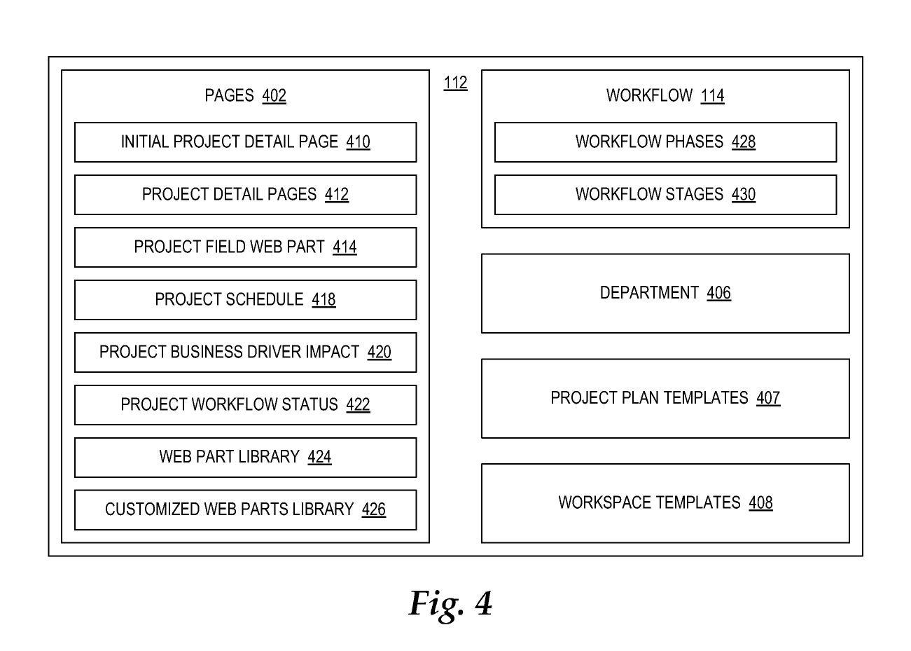

Referring now to FIG. 4, additional details regarding the enterprise project type 112 will be described. In particular, FIG. 4 is a diagram illustrating components contained in the enterprise project type 112. As shown in FIG. 4, the enterprise project type 112 includes pages 402, the workflow 114, departments 406, project plan templates 407, and workspace templates 408. The pages 402 include an initial project page 410, project detail pages 412, a project field web part 414, a project schedule 418, project business driver impact 420, project workflow status 422, a web part library 424, and a customized web parts library 426. The workflow 114 includes workflow phases 428 and workflow stages 430. As used herein, a workflow phase may to a group of workflow stages. In an embodiment, each stage belongs to one phase.

The initial project page 410 is a form enabling a user to initiate an instance of the enterprise project type 112. The project detail pages 412 are the web part pages configured to display the input fields for collecting values of properties. The order in which the project detail pages 412 are displayed may be defined directly in the enterprise project type 112 or specified by the stage which is defined by the workflow 114. The project field web part 414 specifies the grouping and order of the input fields contained in the project detail pages 412. Thus, according to some embodiments, the workflow may specify the stages, the stages may specify pages, and the pages may specify fields, grouping, and order.

The project schedule 418 provides an interface where a user can schedule and assign various tasks for certain people, dates, and times. The project business driver impact 420 provides data regarding the impact of the project business driver. As used herein, a business driver refers to a strategic idea that is set out by senior management in a company. Examples of business drivers may include “Increase customer satisfaction,” “Increase employee morale,” “Expand into Asian markets.” and the like. When a project is defined, the administrator may assess the impact of the project against a business driver. For example, a project like “Acquire Tokyo Bank” may have a significant impact to the business driver “Expand into Asian markets,” but little or no impact to the business driver “Increase customer satisfaction.” Similarly, a project like “Give all employees a merit increase of 10%” may have a significant impact to the business driver “Increase employee morale,” but little or not impact to the business driver “Expand into Asian markets.”

The project workflow status 422 provides data regarding the status of the project workflow. For example, the workflow stage status 316 of FIG. 3 may retrieve and display data from the project workflow status 422. The web part library 424 includes library of WSS and MICROSOFT OFFICE SHAREPOINT SERVER (“MOSS”) web parts. In an embodiment, the web part library 424 includes an interface where a user can drag and drop the WSS and MOSS web parts from the web part library 424 onto the project detail pages 412. The customized web parts library 426 includes user-generated web parts. In an embodiment, the customized web parts library 426 includes an interface where a user can drag and drop the customized web parts from the customized web parts library 426 onto the project detail pages 412.

The workflow phases 428 specify phases of the workflow. As used herein, a workflow phase may refer to a grouping of workflow stages. The administrative interface works may enable an administrator to first define a list of workflow phases that represent big governance gates of a lifecycle such as “Create”, “Select”, “Plan”, “Manage”, “Finalize”, and the like. When a stage is created, the administrative interface may further enable the administrator to select a phase to which the stage belongs. For example, an “Initial Proposal Details” stage may belong to the “Create” phase, a “Selection Review” stage may belong to the “Select” phase, an “Execution” stage may belong to the “Manage” phase, and the like. In some embodiments, a stage belongs to a single phase.

The workflow stages 430 specify the stages included in the enterprise project type, the pages included in each of the stages, and the order in which the stages and pages are displayed to the users. The workflow stages 430 may also specify the state of the input fields (e.g., whether an input field is required, read-write, or read-only) provided by the pages. If the state of the input field is required, then the entity will not advance to the next stage until a value is provided. If the input field is read-only, then the administrator cannot modify the value of the input field. The state of the input fields may also be changed during the life of the workflow. For example, in an enterprise project type, an input field may be configured as required in early stages (e.g., Budget Cost) of the workflow. The same input field may be configured as read-only after the project has been approved.

The department 406 specifies the particular department with which the enterprise project type 112 is associated. In this way, enterprise project types may be filtered according to department through the user interface. Also, certain enterprise project types may be restricted to certain users also through the user interface. For example, users in a given department may only be able to access enterprise project types in that department. The project plan templates 407 include task and schedule templates that can be associated with the enterprise project type 112. The workspace templates 408 include WSS workspace templates that can be associated with the enterprise project type 112.

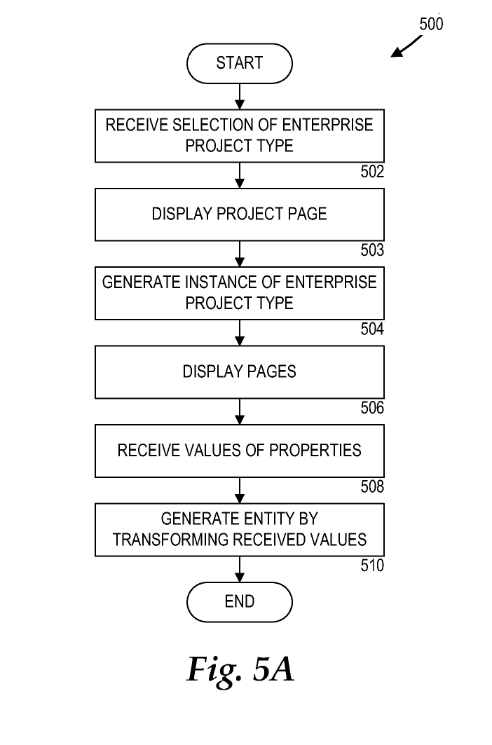

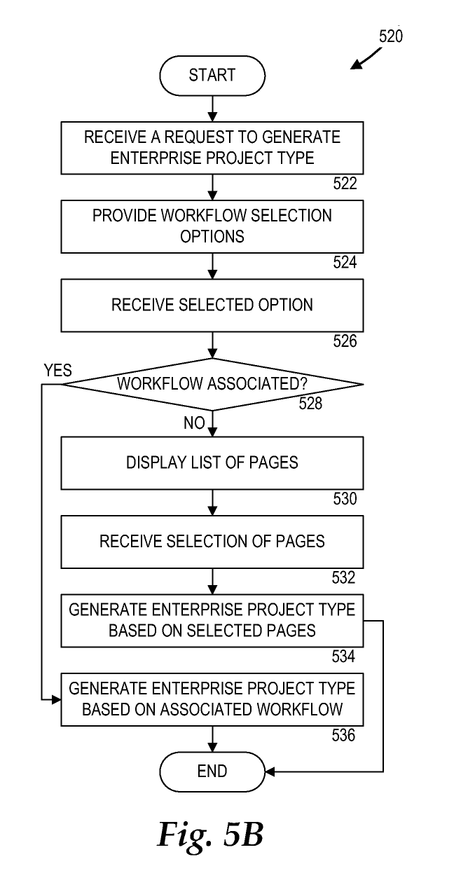

Referring now to FIGS. 5A and 5B, additional details will be provided regarding the embodiments presented herein for providing an enterprise project type. In particular, FIG. 5A is a flow diagram illustrating a method for generating an entity based on an instance of an enterprise project type, in accordance with embodiments. Thus, the method illustrated in FIG. 5A may be directed to the user experience. FIG. 5B is a flow diagram illustrating a method for generating an enterprise project type, in accordance with embodiments. Thus, the method illustrated in FIG. 5B is directed to the administrator experience.

In FIG. 5A, a routine 500 begins at operation 502, where the enterprise project type user module 110 receives a selection of an enterprise project type from a plurality of enterprise project types. For example, the enterprise project type user module 110 may display a drop-down menu with which a user can select an enterprise project type. The routine 500 then proceeds to operation 503, where the enterprise project type user module 110 may display the project page. As previously described, the project page refers to the first page that is displayed when an entity of the enterprise project type is created. The project page may contain various fields as well as a create project button or other interface element for proceeding with the creating the entity. When a selection of the create project interface element is received, the routine 500 proceeds to operation 504, where the enterprise project type user module 110 generates an instance of the selected enterprise project type. The instance of the selected enterprise project type represents an entity, such as a project plan, an application plan, or a product plan. When the enterprise project type user module 110 generates an instance of the selected enterprise project type, the routine 500 proceeds to operation 506.

At operation 506, the enterprise project type user module 110 displays a plurality of pages. Each of the pages may comprise a web part. If the enterprise project type is not associated with a workflow, then the enterprise project type specifies the pages that are displayed. If the enterprise is associated with a workflow, then the workflow specifies the pages that are displayed. The routine 500 then proceeds to operation 508, where the enterprise project type user module 110 receives values of properties through the displayed pages. When the enterprise project type user module 110 receives values of properties through the displayed pages, the routine 500 proceeds to operation 510, where the enterprise project type user module 110 generates an entity based on the received values of properties. In particular, the received values of properties are transformed into the entity, which may represent a project plan, an application plan, or a product plan.

In FIG. 5B, a routine 520 begins at operation 522, where the enterprise project type admin module 108 receives a request to generate an enterprise project type. The routine 520 then proceeds to operation 524, where the enterprise project type admin module 108 provides a plurality of workflow selection options. For example, a first option may have no associated workflow, and a second option may have an associated workflow. When the enterprise project type admin module 108 provides the plurality of workflow selection options, the routine 520 proceeds to operation 526.

At operation 526, the enterprise project type admin module 108 receives one of the workflow selection options. The routine 520 then proceeds to operation 528, where the enterprise project type admin module 108 determines whether the received option has an associated workflow. In the example above, if the enterprise project type admin module 108 receives the first option with no associated workflow, then the routine 520 proceeds to operation 530, where the enterprise project type admin module 108 displays a list of pages. When the enterprise project type admin module 108 displays the list of pages, the routine 520 proceeds to operation 532.

At operation 532, the enterprise project type admin module 108 receives a selection of pages from the list of pages. The routine 520 then proceeds to operation 534, where the enterprise project type is generated based on the selection of pages. In particular, the selected pages are transformed into the enterprise project type. At operation 528 again, if the enterprise project type admin module 108 receives the second option with an associated workflow, then the routine 520 proceeds to operation 536, where the enterprise project type admin module 108 generates the enterprise project type based on the associated workflow. In particular, the workflow is transformed into the enterprise project type.

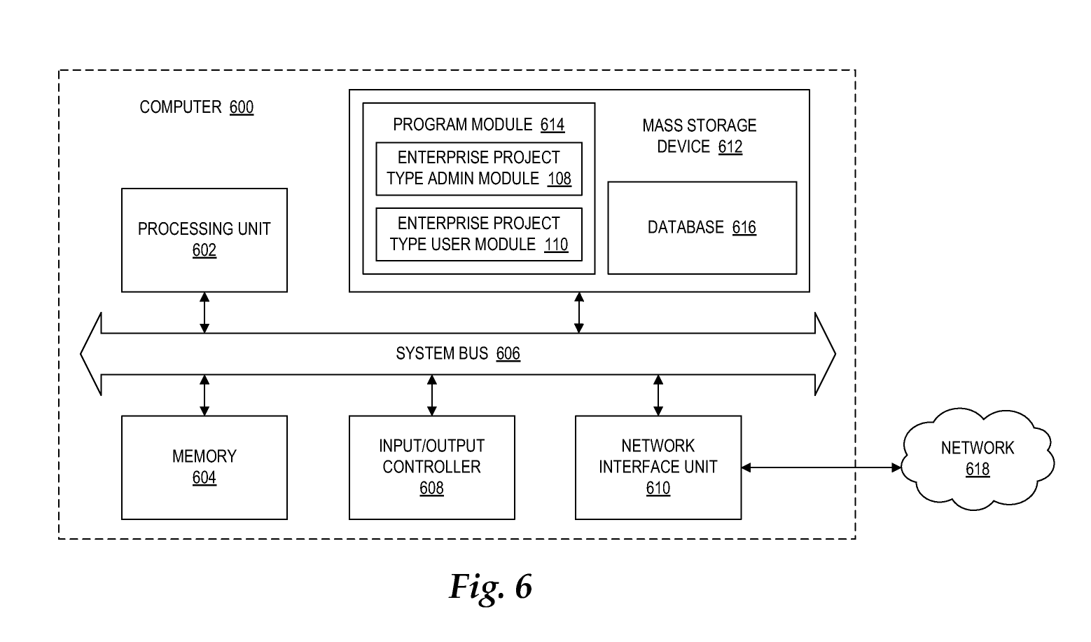

Referring now to FIG. 6, an example computer architecture diagram showing a computer 600 is illustrated. An example of the computer 600 may include the computer 102 of FIG. 1. The computer 600 includes a processing unit 602 (“CPU”), a system memory 604, and a system bus 606 that couples the memory 604 to the CPU 602. The computer 600 further includes a mass storage device 612 for storing one or more program modules 614 and one or more databases 616. Examples of the program modules 614 include the enterprise project type admin module 108 and the enterprise project type user module 110. An example of the databases 616 may be the data store 104 of FIG. 1. The mass storage device 612 is connected to the CPU 602 through a mass storage controller (not shown) connected to the bus 606. The mass storage device 612 and its associated computer-storage media provide non-volatile storage for the computer 600. Although the description of computer-storage media contained herein refers to a mass storage device, such as a hard disk or CD-ROM drive, it should be appreciated by those skilled in the art that computer-storage media can be any available computer storage media that can be accessed by the computer 600.

By way of example, and not limitation, computer-storage media may include volatile and non-volatile, removable and non-removable media implemented in any method or technology for storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 618. The computer 600 may connect to the network 618 through a network interface unit 610 connected to the bus 606. It should be appreciated that the network interface unit 610 may also be utilized to connect to other types of networks and remote computer systems. The computer 600 may also include an input/output controller 608 for receiving and processing input from a number of input devices (not shown), including a keyboard, a mouse, a microphone, and a game controller. Similarly, the input/output controller 608 may provide output to a display or other type of output device (not shown).

The bus 606 may enable the processing unit 602 to read code and/or data to/from the mass storage device 612 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 614 may include software instructions that, when loaded into the processing unit 602 and executed, cause the computer 600 to provide an enterprise project type. The program modules 614 may also provide various tools or techniques by which the computer 600 may participate within the overall systems or operating environments using the components, flows, and data structures discussed throughout this description. For example, the program modules 614 may implement interfaces for generating an enterprise project type and generating an entity based on an instance of the enterprise project type.

In general, the program modules 614 may, when loaded into the processing unit 602 and executed, transform the processing unit 602 and the overall computer 600 from a general-purpose computing system into a special-purpose computing system customized to provide an enterprise project type. The processing unit 602 may be constructed from any number of transistors or other discrete circuit elements, which may individually or collectively assume any number of states. More specifically, the processing unit 602 may operate as a finite-state machine, in response to executable instructions contained within the program modules 614. These computer-executable instructions may transform the processing unit 602 by specifying how the processing unit 602 transitions between states, thereby transforming the transistors or other discrete hardware elements constituting the processing unit 602.

Encoding the program modules 614 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 614 may transform the physical state of the semiconductor memory, when the software is encoded therein. For example, the program modules 614 may transform the state of transistors, capacitors, or other discrete circuit elements constituting the semiconductor memory.

As another example, the computer-storage media may be implemented using magnetic or optical technology. In such implementations, the program modules 614 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for providing an enterprise project type are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for generating an entity based on an instance of an enterprise project type, the method comprising computer-implemented operations for:
receiving a selection of the enterprise project type from a plurality of enterprise project types, the enterprise project type comprising a plurality of pages, each of the pages comprising a plurality of input fields for collecting values of properties;
upon receiving a selection of the enterprise project type, displaying a project page from the selected enterprise project type, the project page comprising a create project interface element;
receiving a selection of the create project interface element;
upon receiving a selection of the create project interface element, generating the instance of the enterprise project type, the instance of the enterprise project type representing an entity;
upon generating the instance of the enterprise project type, displaying the plurality of pages;
receiving the values of properties collected through the pages; and
generating the entity by transforming the values of properties into the entity.

2. The computer-implemented method of claim 1, wherein the entity comprises a project plan, an application plan, or a product plan.

3. The computer-implemented method of claim 1, wherein the plurality of enterprise project types comprise a first enterprise project type with no associated workflow and a second enterprise project type with an associated workflow.

4. The computer-implemented method of claim 3, wherein receiving the selection of an enterprise project type from a plurality of enterprise project types comprises receiving a selection of the first enterprise project type; and wherein the first enterprise project type specifies the plurality of pages that are displayed,

5. The computer-implemented method of claim 3, wherein receiving the selection of an enterprise project type from a plurality of enterprise project types comprises receiving a selection of the second enterprise project type; and wherein the workflow dictates the plurality of pages that are displayed.

6. The computer-implemented method of claim 5, wherein the workflow specifies a plurality of stages; wherein displaying the plurality of pages comprises displaying a plurality of pages contained in a first stage from the plurality of stages; and wherein receiving the values of properties collected through the pages comprises receiving the values of properties collected through the pages contained in the first stage.

7. The computer-implemented method of claim 6, the method further comprising computer-implemented operations for:
upon receiving the values of properties collected through the pages, displaying a plurality of pages contained in a second stage from the plurality of stages; and
receiving the values of properties collected through the pages contained in the second stage;
wherein generating the entity by transforming the values of properties into the entity comprises generating the entity by transforming the values of properties collected through the pages contained in the first stage and the second stage into the entity.

8. The computer-implemented method of claim 1, wherein the enterprise project type is associated with a department.

9. The computer-implemented method of claim 1, wherein each of the plurality of pages comprises one or more web parts.

10. The computer-implemented method of claim 1, the method further comprising computer-implemented operations for:
receiving a request to generate the enterprise project type;
upon receiving the request to generate the enterprise project type, providing a plurality of workflow selection options, the workflow selection options including a first option where no workflow is associated with the enterprise project type and a second option where a workflow is associated with the enterprise project type;
receiving a selection of the first option or the second option from the workflow selection options;
in response to receiving a selection of the first option, displaying a list of pages including the plurality of pages;
receiving a selection of the plurality of pages from the list; and
generating the enterprise project type based on the selection of the plurality of pages.

11. The computer-implemented method of claim 10, the method further comprising computer-implemented operations for:
in response to receiving a selection of the second option, generating the enterprise project type based on the workflow, the workflow dictating the plurality of pages that are displayed.

12. A computer system comprising:
a processor;
a memory operatively coupled to the processor; and
a program module (i) which executes in the processor from the memory and (ii) which, when executed by the processor, causes the computer system to generate an entity based on an instance of an enterprise project type by
receiving a selection of the enterprise project type from a plurality of enterprise project types, the enterprise project type comprising a plurality of pages, each of the pages comprising a plurality of input fields for collecting values of properties,
upon receiving a selection of the enterprise project type, displaying a project page from the selected enterprise project type, the project page comprising a create project interface element.
upon receiving a selection of the create project interface element, generating the instance of the enterprise project type, the instance of the enterprise project type representing an entity, the entity comprising a project plan, an application plan, or a product plan,
upon generating the instance of the enterprise project type, displaying the plurality of pages, each of the plurality of pages comprising a web part,
receiving the values of properties collected through the pages, and
generating the entity by transforming the values of properties into the entity.

13. The computer system of claim 12, wherein the plurality of enterprise project types comprise a first enterprise project type with no associated workflow and a second enterprise project type with an associated workflow.

14. The computer system of claim 13, wherein receiving a selection of the enterprise project type from a plurality of enterprise project types comprises receiving a selection of the first enterprise project type, and wherein the first enterprise project type specifies the plurality of pages that are displayed,

15. The computer system of claim 13, wherein receiving a selection of the enterprise project type from a plurality of enterprise project types comprises receiving a selection of the second enterprise project type; and wherein the workflow dictates the plurality of pages that are displayed.

16. The computer system of claim 15, wherein the workflow specifies a plurality of stages, wherein displaying the plurality of pages comprises displaying a plurality of pages contained in a first stage from the plurality of stages, and wherein receiving the values of properties collected through the pages comprises receiving the values of properties collected through the pages contained in the first stage.

17. The computer system of claim 16, wherein the program module, when executed by the processor, further causes the computer system to generate an entity based on an instance of an enterprise project type by
upon receiving the values of properties collected through the pages, displaying a plurality of pages contained in a second stage from the plurality of stages, and
receiving the values of properties collected through the pages contained in the second stage,
wherein generating the entity by transforming the values of properties into the entity comprises generating the entity by transforming the values of properties collected through the pages contained in the first stage and the second stage into the entity.

18. The computer system of claim 12, wherein the program module, when executed by the processor, further causes the computer system to generate an entity based on an instance of an enterprise project type by
receiving a request to generate the enterprise project type,
upon receiving the request to generate the enterprise project type, providing a plurality of workflow selection options, the workflow selection options including a first option where no workflow is associated with the enterprise project type and a second option where a workflow is associated with the enterprise project type,
receiving a selection of the first option or the second option from the workflow selection options,
in response to receiving a selection of the first option, displaying a list of pages including the plurality of pages,
receiving a selection of the plurality of pages from the list, and
generating the enterprise project type based on the selection of the plurality of pages.

19. The computer system of claim 16, wherein the program module, when executed by the processor, further causes the computer system to generate an entity based on an instance of an enterprise project type by
in response to receiving a selection of the second option, generating the enterprise project type based on the workflow, the workflow dictating the plurality of pages that are displayed based on a current workflow stage.

20. A computer-storage medium having computer-executable instructions stored thereon which, when executed by a computer, cause the computer to:
receive a request to generate an enterprise project type;
upon receiving the request to generate the enterprise project type, provide a plurality of workflow selection options, the workflow selection options including a first option where no workflow is associated with the enterprise project type and a second option where a workflow is associated with the enterprise project type;
receive a selection of the first option or the second option from the workflow selection options;
in response to receiving a selection of the first option, display a project page from the selected enterprise project type and display a list of pages including the plurality of pages, the project page comprising a create project interface element;
receive a selection of the plurality of pages from the list;
generate the enterprise project type based on the selection of the plurality of pages;
in response to receiving a selection of the second option, display the project page from the selected enterprise project type;
receive a selection of the of the create project interface element;
upon receiving a selection of the create project interface element, generate the enterprise project type based on the workflow, the workflow dictating the plurality of pages that are displayed;
in response to receiving a selection of the second option, generate the enterprise project type based on the workflow, the workflow dictating the plurality of pages that are displayed;
receive a selection of the enterprise project type from a plurality of enterprise project types, the enterprise project type comprising a plurality of pages, each of the pages comprising a plurality of input fields for collecting values of properties;
upon receiving a selection of the enterprise project type, generate an instance of the enterprise project type, the instance of the enterprise project type representing an entity, the entity comprising a project plan, an application plan, or a product plan;
upon generating the instance of the enterprise project type, display the plurality of pages;
receive the values of properties collected through the pages, each of the pages comprising a web part; and
generate the entity by transforming the values of properties into the entity.
